(19) United States
(12) Patent Application Publication
(10) Pub. No.: US 2025/0335175 A1
(43) Pub. Date: Oct. 30, 2025

(54) PROGRAMMING METHOD FOR TIRE PRESSURE DETECTOR

(71) Applicant: MOBILETRON ELECTRONICS CO., LTD., Taichung City (TW)

(72) Inventor: WEN-CHUAN HUNG, Taichung City (TW)

(73) Assignee: MOBILETRON ELECTRONICS CO., LTD., Taichung City (TW)

(21) Appl. No.: 19/097,871

(22) Filed: Apr. 2, 2025

(30) Foreign Application Priority Data
Apr. 25, 2024 (TW) 113115569

(51) Int. Cl. G06F 8/65; B60C 23/02; G06F 8/71

(52) U.S. Cl. CPC G06F 8/65; B60C 23/02; G06F 8/71

(57) ABSTRACT

A programming method for a tire pressure detector includes the following steps: a first microcontroller reads first version information of a first program code from a first memory; the first microcontroller transmits the first version information to the programmer; when the first version information is older than the first predetermined version information, the programmer, either actively or under user control, transmits the first predetermined program code to the first microcontroller, and the first predetermined program code is programmed into the first memory, thereby updating the program code of the tire pressure detector.

### BACKGROUND OF THE INVENTION

### Technical Field

The present invention relates generally to a tire detector, and more particularly to a programming method for a tire detector.

### Description of Related Art

A tire pressure monitoring system (TPMS) is an electronic system for monitoring tire pressure, the TPMS including a plurality of tire pressure detectors and a receiver. With the tire pressure detectors installed in each tire, pressures of each tire are obtained and wirelessly transmitted to the receiver in the car to inform a driver of real-time conditions of the tire pressures.

The tire pressure detectors are gradually becoming standard equipment in vehicles. However, different car manufacturers employ varying communication protocols for the TPMS wireless signal transmission thereof. Even within the same car brand, the TPMSs vary based on car models or production years, and various communication protocols are adapted accordingly. Therefore, the tire pressure detectors need to be programmed with a program code of a specific communication program through a programmer so as to program the program code of the same communication program for the newly installed tire pressure detectors, making the wireless signals transmitted accordingly to comply with the corresponding TPMS communication protocol. In addition, when a new version of the program code is available, the existing program code of the tire pressure detectors also needs to be updated.

### BRIEF SUMMARY OF THE INVENTION

In view of the above, the primary objective of the present invention is to provide a programming method for a tire pressure detector, which is able to update program codes of the tire pressure detector.

The present invention provides a programming method for a tire pressure detector, applying to a programming system that includes a programmer and at least one tire pressure detector, the programmer including a memory that stores a first predetermined program code and first predetermined version information of the first predetermined program code. The at least one tire pressure detector includes a wireless communication module and a sensor module, the wireless communication module and the sensor module being in electrical connection. The wireless communication module includes a first microcontroller and a first memory that stores a first program code and first version information of the first program code.

The programming method includes the following steps:
A. reading, by the first microcontroller, the first version information of the first program code from the first memory;
B. transmitting, by the first microcontroller, the first version information of the first program code to the programmer;
C. determining, by the programmer, whether the first version information of the first program code is older than the first predetermined version information of the first predetermined program code, wherein:
when the programmer determines that the first version information of the first program code is older than the first predetermined version information of the first predetermined program code, the programmer transmits the first predetermined program code to the first microcontroller, and the first predetermined program code is programmed into the first memory to update the first program code in the first memory.

With the aforementioned design, when the programmer determines the first program code of the tire pressure detector needs to be updated, the programmer could transmit the first predetermined program code to the tire pressure detector to update the existing first program code.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of a programming system according to a first embodiment of the present invention;

FIG. 2 is a block diagram of a programmer according to the first embodiment of the present invention;

FIG. 3 is a block diagram of a tire pressure detector according to the first embodiment of the present invention;

FIG. 4 is a flow chart of a programming method according to the first embodiment of the present invention;

FIG. 5 is a flow chart, illustrating the programmer method with further details according to the first embodiment of the present invention;

FIG. 6 is a block diagram of a tire pressure detector according to a second embodiment of the present invention;

FIG. 7 is a block diagram of a programmer according to a third embodiment of the present invention;

FIG. 8 is a block diagram of a tire pressure detector according to the third embodiment of the present invention;

FIG. 9 is a block diagram of a tire pressure detector according to a fourth embodiment of the present invention;

FIG. 10 is a flow chart of a programming method according to a fourth embodiment of the present invention; and

FIG. 11 is a flow chart, illustrating the programmer method with further details according to the fourth embodiment of the present invention.

### DETAILED DESCRIPTION OF THE INVENTION

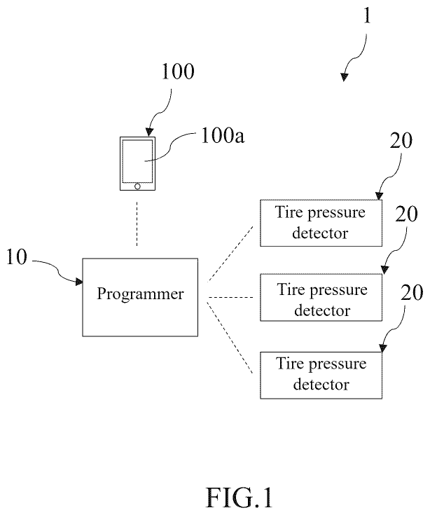

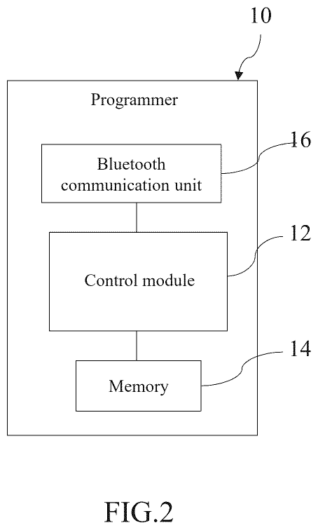

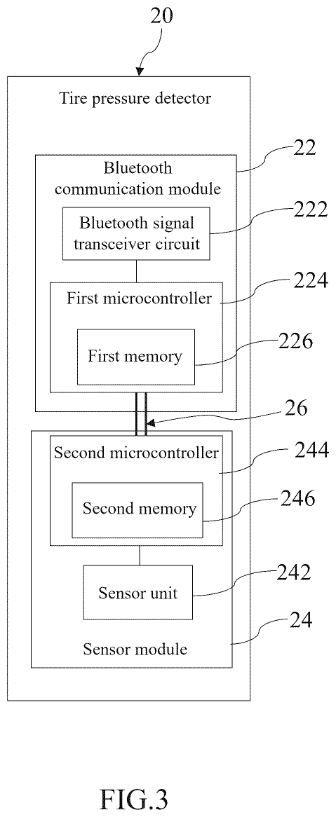

A programming system 1, according to a first embodiment of the present invention, including a programmer 10 and at least one tire pressure detector 20, is illustrated in FIG. 1 to FIG. 3.

The programmer 10 includes a control module 12, a memory 14, and a wireless communication unit exemplified by a Bluetooth communication unit 16. The control module 12 is electrically connected to the memory 14 and the Bluetooth communication unit 16. The memory 14 stores a first predetermined program code and first predetermined version information of the first predetermined program code, along with a second predetermined program code and second predetermined version information of the second predetermined program code. The first predetermined program code is a program code for the tire pressure detector 20 to process wireless signals exemplified by the Bluetooth signals; in the current embodiment, the first predetermined version information is a version number. The second predetermined program code is a program code for the tire pressure detector 20 to process a tire condition; in the current embodiment, the second predetermined version information is a version number. The memory 14 could be a standalone external memory separate from the control module 12 or be an internal memory of the control module 12.

In the current embodiment, the control module 12 communicates with an electronic device 100 through the Bluetooth communication unit 16, and the electronic device 100 may be, for example, a smartphone, a tablet computer, a laptop computer, a desktop computer, etc. The electronic device 100 is configured to run an application to display an operation interface on the screen 100a thereof. The operation interface is provided for a user to operate and select the first predetermined program code and the second predetermined program code. A wireless communication unit, exemplified by a Bluetooth communication unit, of the electronic device 100 communicates with the Bluetooth communication unit 16 of the programmer 10 via Bluetooth signals. The electronic device 100 transmits the first predetermined program code and the second predetermined program code selected by the user to the programmer 10, and the control module 12 stores the first predetermined program code and the second predetermined program code into the memory 14.

The number of the at least one tire pressure detector 20, in the current embodiment, could be plural. Given that each tire pressure detector 20 has the same structure, the following focuses on one tire pressure detector 20 as an illustrative example. The tire pressure detector 20 includes a wireless communication module, exemplified by a Bluetooth communication module 22, and a sensor module 24, wherein the Bluetooth communication module 22 and the sensor module 24 are in electrical connection, and the Bluetooth communication module 22 communicates with the external device, such as the programmer 10 or a receiver (not shown), through wireless signals exemplified by the Bluetooth signals. The sensor module 24 is configured to sense a tire condition, including at least tire pressure, but may further include tire temperature, speed, acceleration, etc. The sensor module 24 transmits the tire condition sensed to the Bluetooth communication module 22 that transmits the tire condition to the receiver.

More specifically, the Bluetooth communication module 22 includes a wireless signal transceiver circuit exemplified by a Bluetooth signal transceiver circuit 222, a first microcontroller 224, and a first memory 226. The Bluetooth signal transceiver circuit 222 and the first memory 226 are electrically connected to the first microcontroller 224. The Bluetooth signal transceiver circuit 222 is configured to receive or transmit the Bluetooth signals. The first memory 226 stores a first program code and first version information of the first program code. The first program code is a program code to process wireless signals exemplified by the Bluetooth signals, and the first predetermined version information is a version number. The first microcontroller 224 executes the first program code to process the Bluetooth signals received and transmitted, for example, to decode or encode the Bluetooth signals. In the current embodiment, the first memory 226 is an internal memory of the first microcontroller 224, but it is not limited thereto; the first memory 226 could also be a standalone external memory separate from the first microcontroller 224. The first microcontroller 224 has a boot loader for updating the first program code in the first memory 226.

The sensor module 24 includes a sensor unit 242, a second microcontroller 244, and a second memory 246, the second microcontroller 244 being electrically connected to the first microcontroller 224, the sensor unit 242, and the second memory 246. The sensor unit 242 is configured to sense the tire condition, the sensor unit 242 at least including a pressure sensor element for sensing tire pressure, but it is not limited thereto; the sensor unit 242 could further include other sensor elements, such as a temperature sensor element, a speed sensor element, and an acceleration sensor element, etc. The second memory 246 stores a second program code and second version information of the second program code. The second program code is a program code to process tire conditions, and the second predetermined version information is a version number. The second microcontroller 244 executes the second program code in the second memory 246 to activate the sensor unit 242 to obtain the tire condition and transmit the tire condition to the first microcontroller 244. The first microcontroller 224 encodes the tire condition to the Bluetooth signal and transmits the Bluetooth signal with the tire condition to the receiver through the Bluetooth signal transceiver circuit 222. The first microcontroller 224 and the second microcontroller 244 are in electrical connection through a serial interface 26 for communication with each other. The second microcontroller 244 has a boot loader for updating the second program code in the second memory 246.

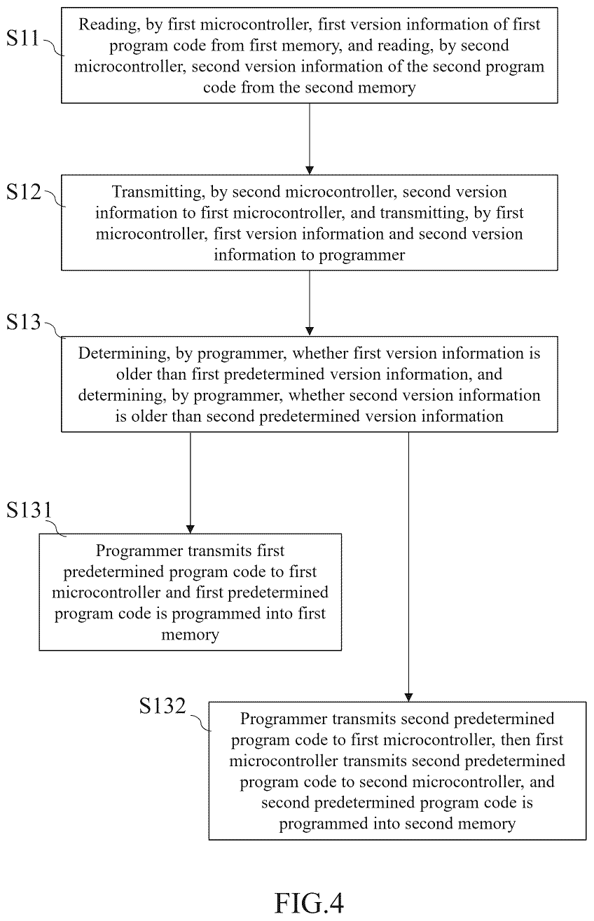

With the aforementioned structure, the programming method based on the present embodiment could be performed. The programming method includes the following steps as shown in FIG. 4. In the current embodiment, given that the steps for programming multiple tire pressure detectors 20 are the same as the steps for programming one tire pressure detector 20, the following focuses on programming one tire pressure detector 20 as an illustrative example.

Step S11: reading, by the first microcontroller 224, the first version information of the first program code from the first memory 226, and reading, by the second microcontroller 244, the second version information of the second program code from the second memory 246.

In the current embodiment, when the first microcontroller 224 and the second microcontroller 244 are idle, they enter a sleep mode to reduce power consumption. Step S11 includes the programmer 10 transmitting a wake-up signal to wake up the first microcontroller 224, the wake-up signal informing the first microcontroller 224 of preparing for program code programming. More specifically, the programmer 10 transmits the wake-up signal via wireless broadcast through the Bluetooth communication unit 16. The Bluetooth signal transceiver circuit 222 of the tire pressure detector 20 receives the wake-up signal to wake up the first microcontroller 224. After the first microcontroller 224 is awakened, the first microcontroller 224 wakes the second microcontroller 244; for example, another wake-up signal is transmitted by the serial interface 26 to the second microcontroller 244. The first microcontroller 224 and the second microcontroller 244, when awakened, read the first version information from the first memory 226 and the second version information from the second memory 246, respectively. Given the fact that the wake-up signal is transmitted via wireless broadcast, the wake-up signal could simultaneously wake up multiple tire pressure detectors 20 that are capable of receiving the wake-up signal.

Step S12: transmitting, by the second microcontroller 244, the second version information of the second program code to the first microcontroller 224 and transmitting, by the first microcontroller 224, the first version information of the first program code and the second version information of the second program code to the programmer 10.

In the current embodiment, the second microcontroller 244 transmits the second version information to the first microcontroller 224 through the serial interface 26. The first microcontroller 224 transmits the first version information of the first program code and the second version information of the second program code to the programmer 10 via wireless broadcast through the Bluetooth signal transceiver circuit 222. In addition, the first microcontroller 224 also transmits a device identification code to the programmer 10 to identify which of the tire pressure detectors 20 transmits the first version information and the second version information.

Step S13: determining, by the programmer 10, whether the first version information of the first program code is older than the first predetermined version information of the first predetermined program code, and determining, by the programmer 10, whether the second version information of the second program code is older than the second predetermined version information of the second predetermined program code, wherein:

Step S131: when the programmer 10 determines that the first version information of the first program code is older than the first predetermined version information of the first predetermined program code, the programmer 10 transmits the first predetermined program code to the first microcontroller 224 and the first predetermined program code is programmed into the first memory 226 to update the first program code in the first memory 226;
Step S132: when the programmer 10 determines that the second version information of the second program code is older than the second predetermined version information of the second predetermined program code, the programmer 100 transmits the second predetermined program code to the first microcontroller 224, then the first microcontroller 224 transmits the second predetermined program code to the second microcontroller 244, and the second predetermined program code is programmed into the second memory 246 to update the second program code in the second memory 246.

In the current embodiment, in step S131, the programmer 10, based on the device identification code received, transmits the first predetermined program code to the first microcontroller 224 corresponding to the device identification code received. The first microcontroller 224 programs the first predetermined program code into the first memory 226 through the boot loader to update the first program code. More specifically, the first microcontroller 224 erases the existing first program code in the first memory 226 and then writes the first predetermined program code into the first memory 226 to form one updated first program code.

In step S132, the programmer 10, based on the device identification code received, transmits the second predetermined program code to the first microcontroller 224 corresponding to the device identification code received. The first microcontroller 224 transmits the second predetermined program code to the second memory 244 through the serial interface 26, and then the second microcontroller 244 programs the second predetermined program code into the second memory 246 through the boot loader to update the second program code. More specifically, the second microcontroller 244 erases the existing second program code in the second memory 246 and then writes the second predetermined program code into the second memory 246 to form one updated second program code.

With the aforementioned steps, when the programmer 10 determines the first program code of the Bluetooth communication module 22 in the tire pressure detector 20 needs to be updated, the programmer 10 actively transmits the first predetermined program code to the tire pressure detector 20 to update the existing first program code; when the programmer 10 determines the second program code of the sensor module 24 in the tire pressure detector 20 needs to be updated, the programmer 10 actively transmits the second predetermined program code to the tire pressure detector 20 to update the existing second program code. In an embodiment, the user could operate the electronic device 100 to connect to the programmer 10, and then the user operates the programmer 10 through the electronic device 100 to transmit the first predetermined program code and/or the second predetermined program code.

To prevent the insufficient strength of the Bluetooth signal from causing errors or incompleteness in the first predetermined program code and the second predetermined program code during transmission, in the current embodiment, prior to step S13, the programmer 10 determines a signal strength, such as received signal strength indication (RSSI), of the wireless broadcast of the tire pressure detector 20 in step S12. When the programmer 10 determines the signal strength is greater than a predetermined strength, the programmer 10 proceeds with step S13; when the signal strength is lower than the predetermined strength, the programmer 10 does not proceed with step S13, thereby ensuring that the transmission of the first predetermined program code and/or the second predetermined program code are allowed to be transmitted only if the Bluetooth signal reaches sufficient strength so that errors or incompleteness do not occur in the program codes during transmission.

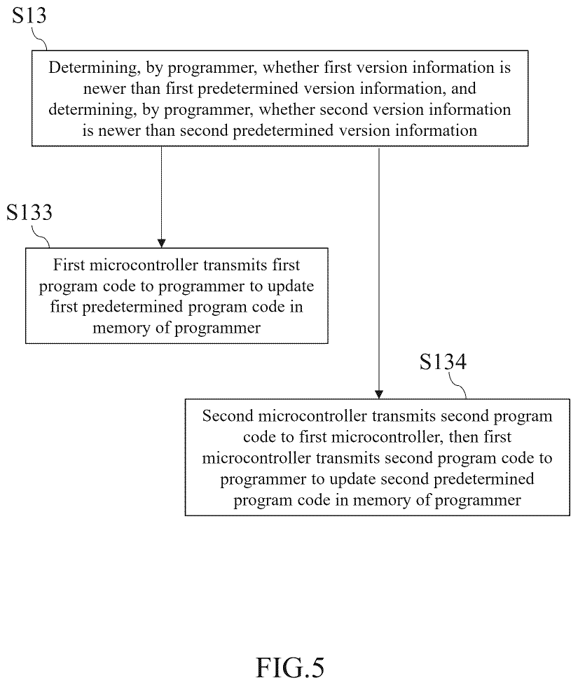

As shown in FIG. 5, in step S13, the programmer 10 further determines whether the first version information of the first program code is newer than the first predetermined version information of the first predetermined program code, and step S13 includes the following.

Step S133: when the programmer 10 determines the first version information of the first program code is newer than the first predetermined version information of the first predetermined program code, the programmer 10 transmits a first upload command to the first microcontroller 224 to command the first microcontroller 224 to transmit the first program code to the programmer 10 so as to update the first predetermined program code in the memory 14 of the programmer 10.

Step S134: when the programmer 10 determines the second version information of the second program code is newer than the second predetermined version information of the second predetermined program code, the programmer 10 transmits a second upload command to the first microcontroller 224. The first microcontroller 224, based on the second upload command, commands the second microcontroller 244 to transmit the second program code to the first microcontroller 224, and the first microcontroller 224 transmits the second program code to the programmer so as to update the second predetermined program code in the memory 14 of the programmer 10.

With step S133 or step S134, the programmer 10 is able to obtain the latest version of the first predetermined program code or the second predetermined program code.

After each tire pressure detector 20 has been updated, the first microcontroller 224 and the second microcontroller 244 are respectively rebooted to execute the first program code updated and the second program code updated.

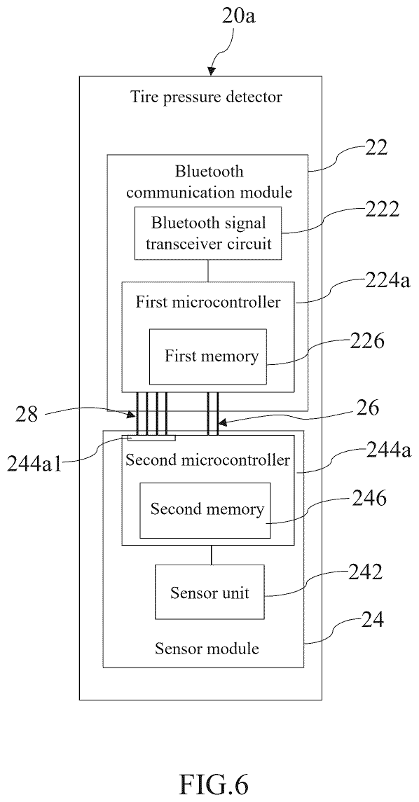

As shown in FIG. 6, a tire pressure detector 20a according to a second embodiment of the present invention is almost the same as the tire pressure detector 20 of the first embodiment, except that the second microcontroller 244a does not have the boot loader, and the first microcontroller 224a is connected to a plurality of programming pins 244a1 of the second microcontroller 244 through a programming interface 28.

In the current embodiment, the programming method includes almost the same steps as those in the first embodiment, except that, in step S32, the first microcontroller 224a transmits the second predetermined program code to the second microcontroller 224a through the programming interface 28 and programs the second predetermined program code into the second memory 246 to update the second program code. In other words, the first microcontroller 224a regards the second memory 246 as an external memory; the first microcontroller 224a erases the existing second program code in the second memory 246 and then writes the second predetermined program code into the second memory 246 to form one updated second program code.

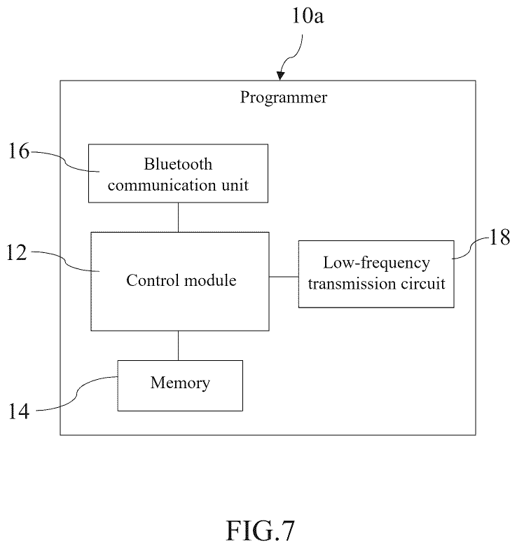

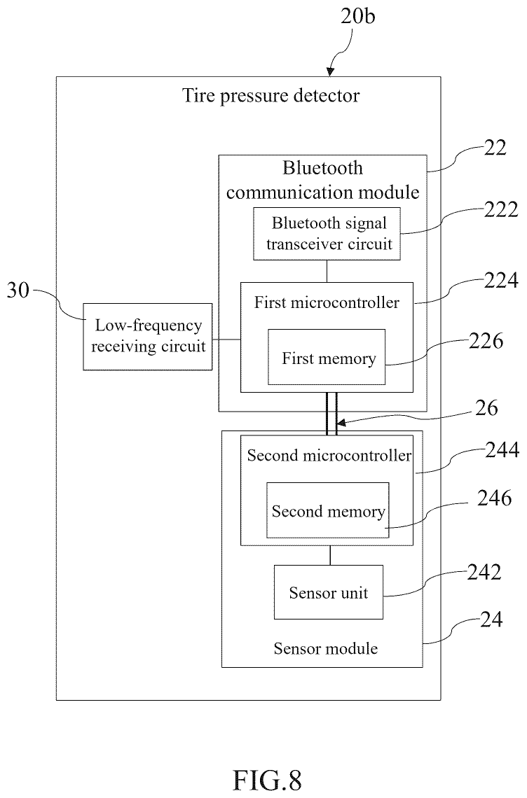

As shown in FIG. 7 and FIG. 8, a programming system, according to a third embodiment of the present invention, is based on the programming system in the first embodiment, wherein the programmer 10a further includes a low-frequency (LF) transmission circuit 18 electrically connected to the control module 12, and the tire pressure detector 20b further includes a low-frequency receiving circuit 30 electrically connected to the first microcontroller 224.

In the current embodiment, the programming method includes almost the same steps as those in the first embodiment, except that, in step S11, the programmer 10a transmits the wake-up signal with low frequency, such as the wake-up signal with 125 KHz, through the low-frequency transmission circuit 18. After the low-frequency receiving circuit 30 of the tire pressure detector 20b receives the wake-up signal, the low-frequency receiving circuit 30 wakes up the first microcontroller 224.

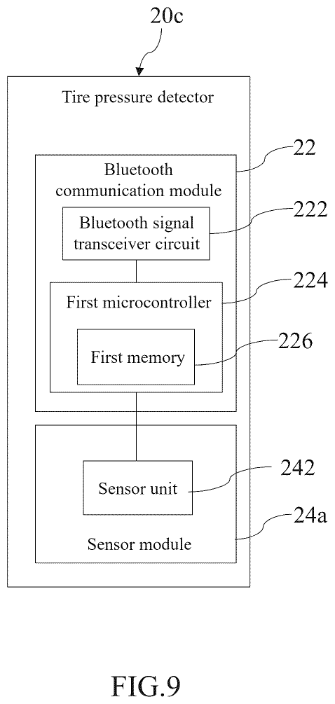

As shown in FIG. 9, a programming system, according to a fourth embodiment of the present invention, is almost the same as the programming system in the first embodiment, except that, in the fourth embodiment, the Bluetooth communication module 22 of each tire pressure detector 20c includes a microcontroller, exemplified by the first microcontroller 224, and a memory, exemplified by the first memory 226. A sensor module 24a of each tire pressure detector 20c does not have the second microcontroller, and the sensor unit 242 is electrically connected to the first microcontroller 224. The first program code stored in the first memory 226 of the Bluetooth communication module 22 in each tire pressure detector 20c is a program code to process wireless signals and the tire conditions. In addition, the first predetermined program code stored in the memory 14 of the programmer 10 is a program code for the tire pressure detector 20c to process wireless signals and the tire conditions.

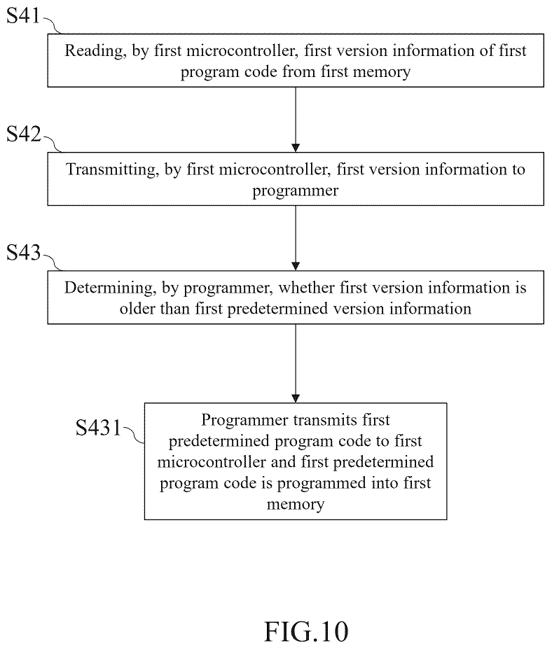

The programming method in the current embodiment is almost the same as the programming method in the first embodiment, the programming method including the following steps as shown in FIG. 10.

Step S41: reading, by the first microcontroller 224, the first version information of the first program code from the first memory 226.

Step S42: transmitting, by the first microcontroller 224, the first version information of the first program code to the programmer 10.

Step S43: determining, by the programmer 10, whether the first version information of the first program code is older than the first predetermined version information of the first predetermined program code, wherein:
Step S431: when the programmer 10 determines that the first version information of the first program code is older than the first predetermined version information of the first predetermined program code, the programmer 10 transmits the first predetermined program code to the first microcontroller 224, and the first predetermined program code is programmed into the first memory 226 to update the first program code in the first memory 226.

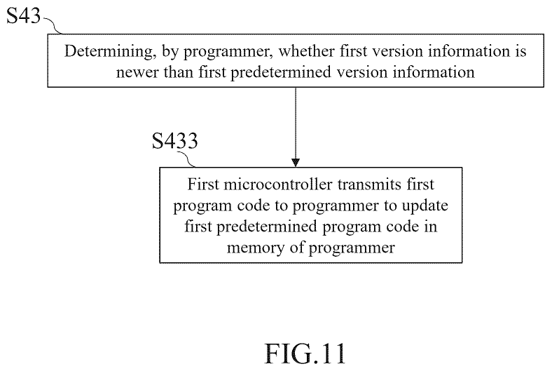

As shown in FIG. 11, in step S43, the programmer 10 further determines whether the first version information of the first program code is newer than the first predetermined version information of the first predetermined program code, and step S43 further includes the following.

Step S433: when the programmer 10 determines the first version information of the first program code is newer than the first predetermined version information of the first predetermined program code, the programmer 10 transmits the first upload command to the first microcontroller 224 to command the first microcontroller 224 to transmit the first program code to the programmer 10 so as to update the first predetermined program code in the memory 14 of the programmer 10.

In an embodiment, each tire pressure detector 20c could also be provided with the low-frequency receiving circuit 30 as that in the third embodiment. In this way, the programming method in the third embodiment could be applied to wake up the first microcontroller 224 by the low-frequency receiving circuit 30 after the low-frequency receiving circuit 30 receives the wake-up signal.

In addition, in the aforementioned first to fourth embodiments, the wireless communication module of each tire pressure detector 20a, 20b, 20c could also be a low-frequency (LF) communication module with 125 KHz, a radio-frequency (RF) communication module with 315 MHz or 433 MHZ, a near-field communication (NFC) module, or a Wi-Fi communication module, while the wireless communication unit of the programmer 10 could be a corresponding low-frequency communication unit, a corresponding radio-frequency communication unit, a corresponding near-field communication unit, or a corresponding Wi-Fi communication unit.

It must be pointed out that the embodiments described above are only some preferred embodiments of the present invention. All equivalent structures which employ the concepts disclosed in this specification and the appended claims should fall within the scope of the present invention.

What is claimed is:

1. A programming method for a tire pressure detector, applying to a programming system that includes a programmer and at least one tire pressure detector, the programmer including a memory that stores a first predetermined program code and first predetermined version information of the first predetermined program code; the at least one tire pressure detector including a wireless communication module and a sensor module, the wireless communication module and the sensor module being in electrical connection; the wireless communication module including a first microcontroller and a first memory that stores a first program code and first version information of the first program code;
the programming method comprising following steps:
A. reading, by the first microcontroller, the first version information of the first program code from the first memory;
B. transmitting, by the first microcontroller, the first version information of the first program code to the programmer;
C. determining, by the programmer, whether the first version information of the first program code is older than the first predetermined version information of the first predetermined program code, wherein:
when the programmer determines that the first version information of the first program code is older than the first predetermined version information of the first predetermined program code, the programmer transmits the first predetermined program code to the first microcontroller, and the first predetermined program code is programmed into the first memory to update the first program code in the first memory.

2. The programming method for the tire pressure detector as claimed in claim 1, wherein the memory of the programmer stores a second predetermined program code and second predetermined version information of the second predetermined program code; wherein the sensor module includes a second microcontroller and a second memory that stores a second program code and second version information of the second program code;
wherein step A includes reading, by the second microcontroller, the second version information of the second program code from the second memory;
wherein step B includes transmitting, by the second microcontroller, the second version information of the second program code to the first microcontroller and transmitting, by the first microcontroller, the second version information of the second program code to the programmer;
wherein step C includes determining, by the programmer, whether the second version information of the second program code is older than the second predetermined version information of the second predetermined program code, wherein, when the programmer determines that the second version information of the second program code is older than the second predetermined version information of the second predetermined program code, the programmer transmits the second predetermined program code to the first microcontroller, then the first microcontroller transmits the second predetermined program code to the second microcontroller, and the second predetermined program code is programmed into the second memory to update the second program code in the second memory.

3. The programming method for the tire pressure detector as claimed in claim 2, wherein the first microcontroller and the second microcontroller are connected through a serial interface; the second microcontroller has a boot loader, wherein, in step C, when the programmer determines that the second version information of the second program code is older than the second predetermined version information of the second predetermined program code, the first microcontroller transmits the second predetermined program code to the second microcontroller through the serial interface, and the second microcontroller programs the second predetermined program code into the second memory through the boot loader to update the second program code.

4. The programming method for the tire pressure detector as claimed in claim 2, wherein the second memory is an internal memory of the second microcontroller, and the first microcontroller and the second microcontroller are connected to each other through a programming interface; in step C, when the programmer determines that the second version information of the second program code is older than the second predetermined version information of the second predetermined program code, the first microcontroller transmits the second predetermined program code to the second microcontroller through the programming interface and the second predetermined program code is programmed into the second memory to update the second program code.

5. The programming method for the tire pressure detector as claimed in claim 1, wherein step A includes the programmer transmitting a wake-up signal to wake up the first microcontroller of the at least one tire pressure detector.

6. The programming method for the tire pressure detector as claimed in claim 5, wherein the programmer includes a wireless communication unit; in step A, the programmer transmits the wake-up signal to the at least one tire pressure detector via wireless broadcast through the wireless communication unit.

7. The programming method for the tire pressure detector as claimed in claim 5, wherein the programmer includes a low-frequency transmission circuit; the first microcontroller is connected to a low-frequency receiving circuit; wherein, in step A, the programmer transmits the wake-up signal through the low-frequency transmission circuit, and the low-frequency receiving circuit wakes up the first microcontroller after the low-frequency receiving circuit receives the wake-up signal.

8. The programming method for the tire pressure detector as claimed in claim 5, wherein, in step B, the first microcontroller transmits the first version information of the first program code to the programmer via wireless broadcast.

9. The programming method for the tire pressure detector as claimed in claim 8, wherein, in step B, the first microcontroller transmits a device identification code to the programmer; in step C, the programmer transmits the first predetermined program code to the first microcontroller based on the device identification code.

10. The programming method for the tire pressure detector as claimed in claim 8, wherein, prior to step C, the programmer determines a signal strength of the wireless broadcast of the at least one tire pressure detector; when the programmer determines the signal strength is greater than a predetermined strength, the programmer proceeds with step C.

11. The programming method for the tire pressure detector as claimed in claim 1, wherein, in step C:
when the programmer determines the first version information of the first program code is newer than the first predetermined version information of the first predetermined program code, the programmer commands the first microcontroller to transmit the first program code to the programmer to update the first predetermined program code in the memory of the programmer.

12. The programming method for the tire pressure detector as claimed in claim 2, wherein, in step C:
when the programmer determines the second version information of the second program code is newer than the second predetermined version information of the second predetermined program code, the programmer commands the second microcontroller to transmit the second program code to the first microcontroller, and the first microcontroller transmits the second program code to the programmer to update the second predetermined program code in the memory of the programmer.
